(19) United States
(12) Patent Application Publication
(10) Pub. No.: US 2026/0202865 A1
(43) Pub. Date: Jul. 16, 2026

(54) BACK PRESSURE REGULATOR VALVE

(71) Applicant: Spraying Systems Co.,, Wheaton, IL (US)

(72) Inventors: Paul Wanthal, Bartlett, IL (US); Timothy Winter, Vernon Hills, IL (US); Marc Arenson, South Elgin, IL (US)

(73) Assignee: Spraying Systems Co., Wheaton, IL (US)

(21) Appl. No.: 19/449,094

(22) Filed: Jan. 14, 2026

Related U.S. Application Data
(60) Provisional application No. 63/744,907, filed on Jan. 14, 2025.

(51) Int. Cl. G05D 16/06; B05B 12/08

(52) U.S. Cl. CPC G05D 16/0641; B05B 12/088; G05D 16/0636

(57) ABSTRACT

A back pressure regulator valve has a fluid inlet passage and a fluid outlet passage. An array of circular and concentric grooves are provided in a valve body. Each of the grooves has a continuously variable depth. Each of a plurality of first grooves has a depth that reaches a maximum where the groove communicates with the fluid outlet passage and reaches a minimum adjacent the fluid inlet passage where the groove does not communicate with the fluid inlet passage. Each of a plurality of second grooves has a depth that reaches a maximum where the \groove communicates with the fluid inlet passage and reaches a minimum adjacent the fluid outlet passage where the groove does not communicate with the fluid outlet passage. The array of grooves alternates between first grooves and second grooves. A flexible diaphragm is arranged to cover the array of grooves.

### CROSS-REFERENCE TO RELATED APPLICATION

This patent application claims the benefit of U.S. Provisional Patent Application No. 63/744,907, filed Jan. 14, 2025, which is incorporated by reference.

### BACKGROUND OF THE INVENTION

Many spraying systems are designed to provide back pressure control. Back pressure control can help provide agitation, facilitate flushing, give fast response, or provide pressure control in spraying systems that utilize positive-displacement pumps. One way in which this pressure control can be provided is using a back pressure regulator valve. A back pressure regulator valve is a type of pressure control valve in which the fluid pressure upstream from the valve (i.e., on the inlet side of the valve) is controlled by the back pressure regulator valve.

In spraying systems utilizing backpressure control, the nozzles and nozzle control valves are located in a liquid line or manifold located downstream of a liquid supply, e.g. a pump and liquid supply vessel, and upstream from the pressure control element, e.g. back pressure regulating valve. In operation, a back pressure regulator bypasses some liquid back to the liquid supply vessel at all times. When the nozzles of the spraying system are not spraying, all the flow from the liquid supply passes through the orifice of the back pressure regulator, resulting in a temporary increase in pressure. An appropriate adjustment to the orifice geometry of the regulator that increases its flow area will hold the upstream pressure constant. When the nozzles are spraying, the additional flow through the nozzles results in a temporary reduction in pressure. An appropriate decrease in the flow area of the regulator will keep the pressure at the desired setpoint. An ideal back pressure regulating valve can detect the change in upstream pressure and bypass sufficient fluid to keep the pressure upstream of the spray nozzles at a constant value as the flow demand changes. If the flow demand through the nozzles increases, the regulator closes to some extent. If the flow demand decreases, the regulator opens wider to maintain the pressure.

Several types of back pressure regulator valves are commercially available. Some use a diaphragm or piston connected to spherical or conical seat geometry to create a variable orifice. Others use a rubber diaphragm to vary the number of holes in a plate that are exposed for fluid flow-through. To facilitate remote operation, in some cases the controlling force to the piston or diaphragm is supplied by regulated compressed air on the opposite side of the piston or diaphragm.

### OBJECTS OF THE INVENTION

In view of the foregoing, a general object of the present invention is to provide a back pressure regulator valve for spraying systems having a design that is relatively compact for the flow required.

Another object of the present invention is to provide a back pressure regulator valve of the foregoing type which has a long lifespan and requires minimal maintenance.

A further object of the present invention is to provide a back pressure regulator valve that reacts quickly to changing flow conditions in a spraying system.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWINGS

FIG. 1 is a schematic diagram of an exemplary spraying system including a back pressure regulator valve according to the present disclosure.

FIG. 2 is a schematic diagram of an alternative embodiment of a spraying system including a back pressure regulator valve according to the present disclosure.

FIG. 3 is a perspective view of an exemplary back pressure regulator valve according to the present disclosure.

FIG. 4 is a cross-sectional view of the back pressure regulator valve of FIG. 3.

FIG. 5 is a partially cutaway, perspective view of the back pressure regulator valve of FIG. 3 with the loading dome removed.

FIG. 6 is a plan view of an inner surface of the loading dome of the back pressure regulator valve of FIG. 3.

### DETAILED DESCRIPTION OF THE INVENTION

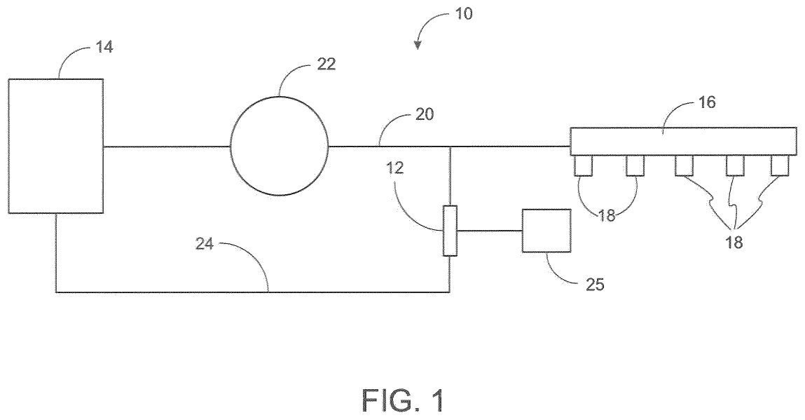

Referring to FIG. 1 of the drawings, there is shown an exemplary embodiment of a spraying system 10 having a back pressure regulator valve 12 according to the present invention. The illustrated spraying system generally includes a fluid supply vessel 14, such as in the form of a tank, and a spray manifold 16 equipped, in this case, with a plurality of spray nozzles 18. The supply vessel 14 and the spray manifold 16 in the illustrated embodiment are interconnected by a fluid supply line 20. A pump 22 is arranged in the fluid supply line 20 between the fluid supply vessel 14 and the spray manifold 16 and is arranged and configured to direct fluid from the fluid supply vessel 14 to the spray manifold 16 and associated spray nozzles 18 under pressure. While the illustrated embodiment includes a spray manifold 16 on which spray nozzles 18 are supported, other embodiments may use a header or other structure for supporting and directing fluid to the spray nozzles. Also, while the illustrated embodiment includes a plurality of spray nozzles 18, other embodiments may include only a single spray nozzle. Similarly, the present disclosure is not limited to the use of any particular type of spray nozzle. Again, any desired type of spray nozzle producing any desired spray pattern may be used depending on the needs of the particular application. Spraying systems 10 such as illustrated in FIG. 1 are used in many industrial applications for directing a curtain of a fluid into or onto a spray target. As will become apparent to one skilled in the art, the back pressure regulator valve 12 and associated spraying system 10 of the present disclosure may be used to spray various liquid substances, including foods, pharmaceuticals, chemicals, or like substances, in different processing environments.

In order to provide back pressure control, a back pressure regulator valve 12 is arranged, in the illustrated spraying system, between the pump 22 and the spray manifold 16. More specifically, the back pressure regulator valve 12 is arranged in a fluid return line 24 and is operable, as discussed in more detail below, to help control the fluid pressure in the manifold 16 and fluid supply line 20 upstream of the spray nozzles 18 and downstream of the pump 22. In operation, the back pressure regulator valve 12 has a variable orifice geometry which can vary the flow through the fluid return line 24 and thereby control the pressure as desired in the fluid line 20 and spray manifold 16. Generally, the back pressure regulator valve 12 opens to allow more flow through the return line 24 in order to prevent pressure spikes in the fluid supply line 20 and spray manifold 16 such as when the spray nozzles 18 are not spraying. Conversely, the back pressure regulator valve 12 closes or reduces the flow through the return line 24 when the spray nozzles 18 are discharging in order to help maintain pressure in the fluid supply line 20 and spray manifold 16. The back pressure regulator valve 12 is configured to vary the degree to which the valve is open or closed to provide precise back pressure control. In the embodiment illustrated in FIG. 1, the spraying system 10 includes a compressed air source 25 which helps control the opening and closing of the back pressure regulator valve as further discussed below.

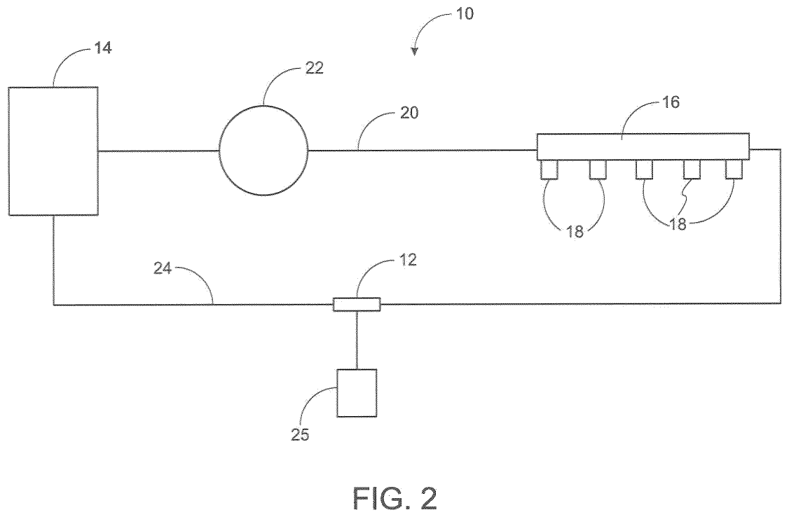

An alternative embodiment of a spraying system with a back pressure regulator valve 12 according to the present disclosure is shown in FIG. 2. In the embodiment of FIG. 2, the back pressure regulator valve 12 and the return line 24 are downstream of the spray manifold 28 and spray nozzles 18. As with the embodiment of FIG. 1, the return line 24 communicates with the fluid supply vessel 14 upstream of the pump 22. In contrast to the embodiment of FIG. 1, the arrangement of FIG. 2 facilitates flushing of the spraying system.

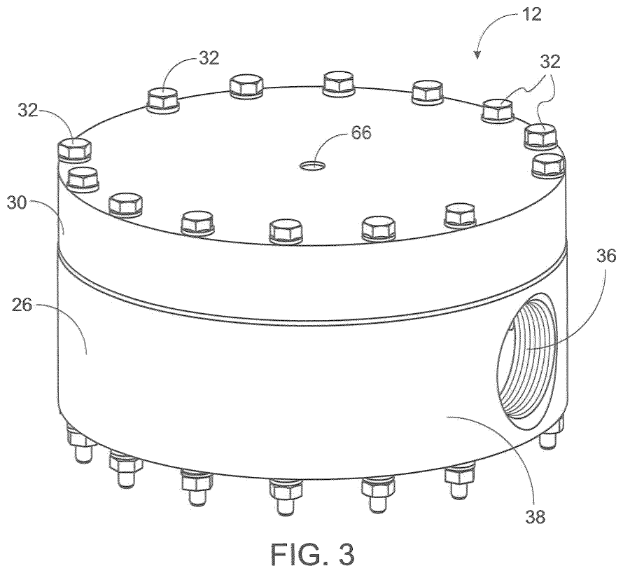

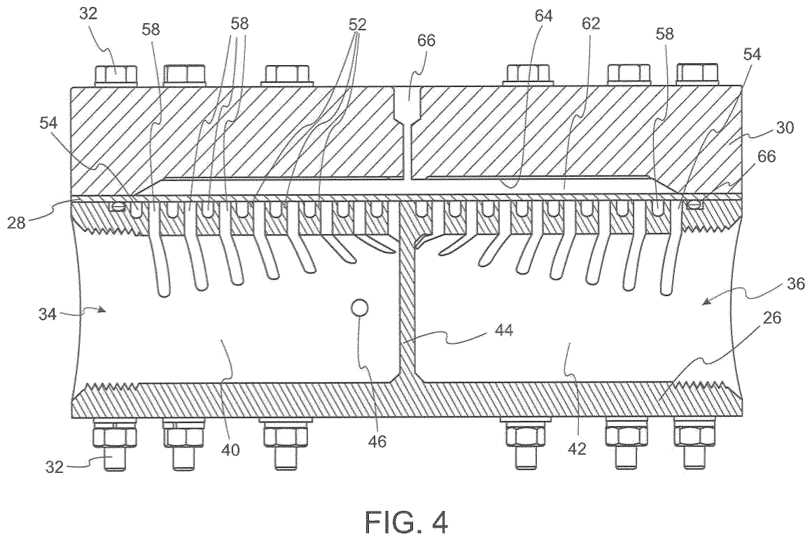

Referring to FIGS. 3-4 of the drawings there is shown an illustrative embodiment of the back pressure regulator valve 12 of the present invention. The illustrated back pressure regulator 12 valve includes a cylindrical valve body 26, an elastomeric diaphragm 28, and a cylindrical pressure loading cover or dome 30 arranged in a stack and secured, in this case, with fasteners 32 around the perimeter. While the illustrated back pressure regulator valve 12 has a generally cylindrical configuration, other configurations also could be used. As shown in FIG. 4, the valve body 26 includes a fluid inlet 34 and a fluid outlet 36. The fluid inlet 34 may be a straight walled or drafted inlet and have a diameter commensurate with the flow requirements of the particular application in which the back pressure regulator valve 12 is to be used. The fluid inlet 34 is arranged in a side wall 38 of the valve body 26 and communicates with an inlet passage 40 that terminates just under halfway across the diameter of the valve body 26. The fluid outlet 36 is on the opposite side of the valve body 26, coaxial with inlet 34. The fluid outlet 36 communicates with an outlet passage 42 that also terminates at just under half the diameter of the valve body 26. A partition wall 44 that extends diametrically in the valve body 26 separates the inlet passage 40 and the outlet passage 42. In this case, a pressure sensing port 46 is provided in the side wall 38 of the valve body 26 which allows attachment of, for example, a sensor for closed loop control of the spraying system 10 or a gauge for visual feedback.

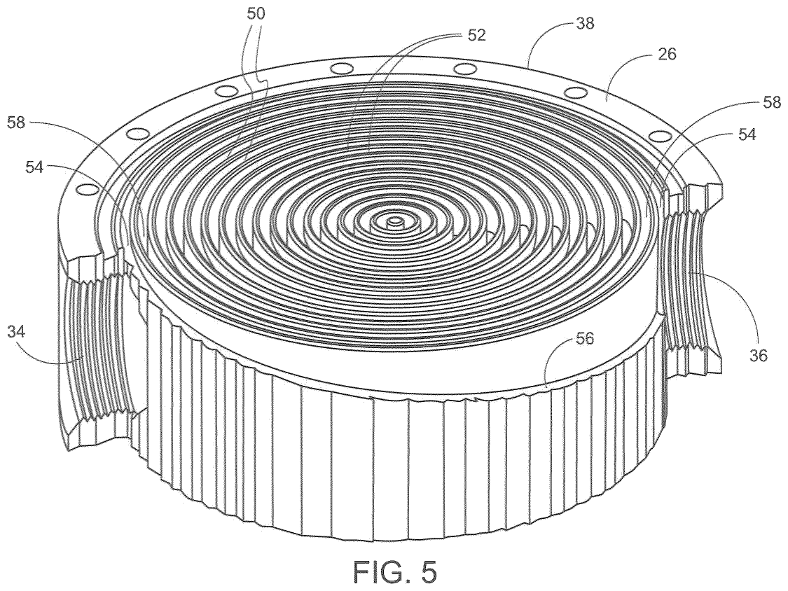

To facilitate variable fluid flow from the fluid inlet 34 to the fluid outlet 36, an end wall of the valve body 26 includes an array of concentric grooves 50 that are separated by a series of concentric vanes 52. Each of the concentric grooves 50 has a continuously variable depth as it extends circumferentially. More specifically, the depth of the outermost groove 54 reaches its maximum adjacent the fluid outlet port 36, where the respective groove 54 communicates with the bore of outlet passage 42. From the point of maximum depth and in either direction, the depth of the outermost groove 54 decreases along a helical path 56 depicted in the cutaway of FIG. 5, reaching a minimum adjacent the bore of the inlet passage 40 where the groove 54 does not intersect the inlet passage 40. In a similar manner, the radially, inwardly next concentric groove 58 is of maximum depth over the inlet passage 40 and communicating with the inlet passage 40, with the depth decreasing in either direction around the circumference of the groove 58 and reaching a minimum over the outlet passage 42, and not intersecting the outlet passage 42. Moving radially inward, the pattern repeats, with alternate grooves 50 communicating with either the inlet passage 40 or outlet passage 42.

The opposite pattern also may be used for the array of concentric grooves 50 with the radially outermost groove 54 reaching its maximum depth where it communicates with the inlet passage 40 and the next radially inward groove 58 communicating with the outlet passage 42. In this respect, the array of concentric grooves 50 can be considered to include a set of first grooves, with a depth of each of the first grooves reaching a maximum depth where the respective first groove intersects the fluid outlet passage and reaching a minimum depth adjacent the fluid inlet passage where the respective first groove does not communicate with the fluid inlet passage. The concentric circular grooves further includes a set of second grooves, with a depth of each second groove reaching a maximum depth where the respective second groove intersects the fluid inlet passage and reaching a minimum depth adjacent the fluid outlet passage where the respective second groove does not communicate with the fluid outlet passage.

The diaphragm 28 is positioned to cover the grooves 50 in the valve body 26 and is circumferentially sealed to the valve body 26 (i.e., sealed about the perimeter), such as by an O-ring 60 or bead molded into the diaphragm 28. Thus arranged, the diaphragm 28 forms a flexible cover over the array of grooves 50. With the diaphragm 28 resting on the vanes 52 separating the grooves 50, fluid flowing into the valve body 26 passes through slots formed by the intersection of the grooves 50 with the inlet passage 40. The fluid then travels around alternate grooves across the entire face of the array of groove 50, pushing the diaphragm 28 away from the upper edge of the vanes 52. This allows fluid to pass over the crests of the vanes 52 and into adjacent grooves 50 communicating with the fluid outlet passage 42. Thus, the fluid is transmitted via these grooves to the outlet passage 42 from which it can exit the valve body 26 through the fluid outlet 36.

The pressure loading cover or dome 30 is positioned over the diaphragm 28 and circumferentially sealed to the diaphragm 28 (i.e., sealed about the perimeter). The loading dome 30 may be sealed to the diaphragm using any appropriate means including, for example, an O-ring, a bead molded into the diaphragm 28 or the diaphragm's intrinsic elastomeric properties. The loading dome 30 defines a domed chamber 62 between the underside 64 of the loading dome 30 and the diaphragm 28 that allows deflection of the diaphragm 28 under fluid pressure. The domed chamber 62 is configured to allow sufficient deflection of the diaphragm 28 for liquid flow between individual grooves of the groove array 50. In particular, liquid flows over the vanes 52 separating the grooves 50 in the space between the upper edges of the vanes and the diaphragm 28. The underside 64 of the loading dome 62 serves to limit the maximum strain on the diaphragm 28 to prevent undue fatigue.

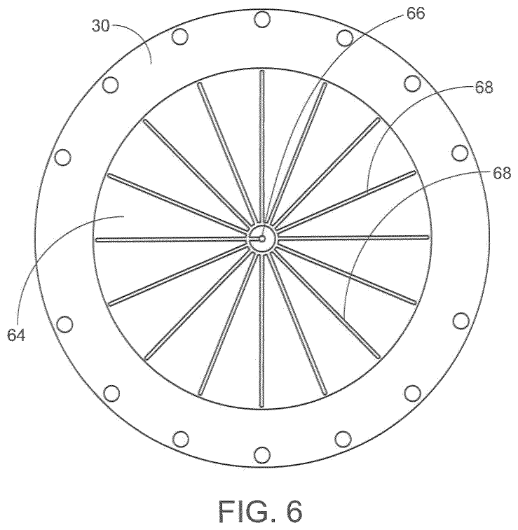

As shown in FIG. 4, a control port 66 is provided in the loading dome 30 that is in communication with the domed chamber 62 to facilitate regulation of air pressure in the domed chamber 62. Regulation of the air pressure in the domed chamber 62, in turn, allows for control of fluid pressure in the spraying system 10 upstream of the valve inlet 34. More particularly, the presence of pressurized air in the domed chamber 62 produces a downward force on the upper surface of the diaphragm 28. This downward force opposes the liquid pressure force pushing upward on the lower surface of the diaphragm 28, reducing the liquid flow path across the vanes 52 and correspondingly raising the fluid pressure at inlet 34 and upstream of the back pressure regulator valve 12 in the spraying system 10. Conversely, reducing the pressure in the domed chamber 62 allows more upward deflection of the diaphragm 28 thus enlarging the liquid flow path across the vanes 52 and thus lowering the fluid pressure upstream of the inlet 32 to the valve body 26. The control port 66 may be connected to a compressed air source which may be operable to adjust the air pressure in the domed chamber 62. During normal operation, the air pressure above diaphragm 28 is adjusted to reach equilibrium with the liquid pressure force beneath the diaphragm 28 such that the deflection of diaphragm 28 will allow some flow through the back pressure regulator valve 12. In the simplest case of a trapped volume of air in the domed chamber 62, deflection of the diaphragm 28 will reduce the volume in the domed chamber 62, causing an increase in the air pressure, which in turn increases the force opposing the liquid pressure force on the diaphragm 28. In this way, the process becomes self-regulating. As shown in FIG. 6, the underside 64 of the loading dome 30 has an array of shallow radially extending grooves 68 to help prevent air from getting trapped around the periphery of the control port 66. In this manner, the diaphragm moves freely while the forces on either side are in balance; control may be lost if excess control pressure in the domed chamber 62 causes the diaphragm 28 to seal off completely against the vanes 52, or if the control pressure is insufficient to prevent the entirety of the diaphragm 28 from deflecting to the underside 64 of the pressure loading dome 30.

In another embodiment, pressurized process fluid upstream of the back pressure regulator valve 12 may be used as an alternative to using compressed air in the domed chamber 62. Such an arrangement eliminates the need for a compressed air source. Implementation of this control method is dependent on the ratio of control pressure/regulated liquid pressure being less than unity, which is a characteristic of the illustrated valve body design.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A back pressure regulator valve comprising:
a valve body having a fluid inlet in communication with a fluid inlet passage in the valve body and a fluid outlet in communication with a fluid outlet passage in the valve body;
wherein an array of grooves that are circular and concentric are provided in an end wall of the valve body that are separated by an array of concentric vanes, with each of the grooves having a continuously variable depth as the respective groove extends circumferentially;
wherein the array of grooves includes a plurality of first grooves, a depth of each of the first grooves reaches a maximum depth where the respective first groove communicates with the fluid outlet passage and reaches a minimum depth adjacent the fluid inlet passage where the respective first groove does not communicate with the fluid inlet passage;
wherein the array of grooves includes a plurality of second grooves, a depth of each second groove reaches a maximum depth where the respective second groove communicates with the fluid inlet passage and reaches a minimum depth adjacent the fluid outlet passage where the respective second groove does not communicate with the fluid outlet passage;
wherein the array of grooves alternates between first grooves and second grooves in a radial direction of the array of grooves;
wherein the fluid inlet passage and the fluid outlet passage each extend in the radial direction relative to the array of grooves; and
a flexible diaphragm arranged to cover the array of grooves, the flexible diaphragm having a rest position where the flexible diaphragm rests on the array of vanes separating the array of grooves and the diaphragm being movable away from upper edges of the array of vanes in response to the presence of fluid in the one or more of the grooves to allow for fluid flow between adjacent grooves over the respective vane separating the adjacent grooves.

2. The back pressure regulator valve of claim 1, further including a pressure loading cover arranged over the diaphragm and the array of grooves.

3. The back pressure regulator valve of claim 2, wherein the pressure loading cover defines a chamber between an underside of the pressure loading cover and the diaphragm that allows for the movement of the diaphragm away from the upper edges of the array of grooves.

4. The back pressure regulator valve of claim 3, wherein the pressure loading dome includes a control port that is in communication with the chamber to allow for regulation of air pressure in the chamber.

5. The back pressure regulator valve of claim 4, wherein the control port communicates with a pressurized air source.

6. The back pressure regulator valve of claim 5, wherein the underside of the pressure loading dome has a plurality of grooves therein.

7. The back pressure regulator valve of claim 2, wherein the valve body has a cylindrical configuration and the pressure loading cover is configured as a dome.

8. The back pressure regulator valve of claim 2, wherein a perimeter of the diaphragm is sealed to the valve body.

9. The back pressure regulator valve of claim 8, wherein the pressure loading cover is sealed to the perimeter of the diaphragm.

10. A spraying system comprising:
a fluid supply;
a fluid supply line;
a spray nozzle in communication with the fluid supply line;
a pump arranged in the fluid supply line between the fluid supply and the spray nozzle;
a back pressure regulator valve communicating with a fluid return line; the back pressure regulator valve being arranged and configured to control pressure in the spray nozzle and in the fluid supply line between the spray nozzle and the pump;
the back pressure regulator valve comprising:
a valve body having a fluid inlet in communication with a fluid inlet passage in the valve body and a fluid outlet in communication with a fluid outlet passage in the valve body;
wherein an array of grooves that are circular and concentric are provided in an end wall of the valve body that are separated by an array of concentric vanes, with each of the grooves having a continuously variable depth as the respective groove extends circumferentially;
wherein the array of grooves includes a plurality of first grooves, a depth of each of the first grooves reaches a maximum depth where the respective first groove communicates with the fluid outlet passage and reaches a minimum depth adjacent the fluid inlet passage where the respective first groove does not communicate with the fluid inlet passage;
wherein the array of grooves includes a plurality of second grooves, a depth of each second groove reaches a maximum depth where the respective second groove communicates with the fluid inlet passage and reaches a minimum depth adjacent the fluid outlet passage where the respective second groove does not communicate with the fluid outlet passage;
wherein the array of grooves alternates between first grooves and second grooves in a radial direction of the array of grooves;
wherein the fluid inlet passage and the fluid outlet passage each extend in the radial direction relative to the array of grooves; and
a flexible diaphragm arranged to cover the array of grooves, the flexible diaphragm having a rest position where the flexible diaphragm rests on the array of vanes separating the array of grooves and the diaphragm being movable away from upper edges of the array of vanes in response to the presence of fluid in the one or more of the grooves to allow for fluid flow between adjacent grooves over the respective vane separating the adjacent grooves.

11. The spraying system of claim 10, further including a pressure loading cover arranged over the diaphragm and the array of grooves.

12. The spraying system of claim 11, wherein the pressure loading cover defines a chamber between an underside of the pressure loading cover and the diaphragm that allows for the movement of the diaphragm away from the upper edges of the array of grooves.

13. The spraying system of claim 12, wherein the pressure loading dome includes a control port that is in communication with the chamber to allow for regulation of air pressure in the chamber.

14. The spraying system of claim 13, wherein the control port communicates with a pressurized air source.

15. The spraying system of claim 14, wherein the underside of the pressure loading dome has a plurality of grooves therein.

16. The spraying system of claim 11, wherein the valve body has a cylindrical configuration and the pressure loading cover is configured as a dome.

17. The spraying system of claim 11, wherein a perimeter of the diaphragm is sealed to the valve body.

18. The spraying system of claim 17, wherein the pressure loading cover is sealed to the perimeter of the diaphragm.
